(19) United States
(12) Patent Application Publication
(10) Pub. No.: US 2026/0073368 A1
(43) Pub. Date: Mar. 12, 2026

(54) NATIVE CRYPTOCURRENCY PAYMENT SYSTEM

(71) Applicant: Thirdwayv, Inc., Irvine, CA (US)

(72) Inventors: Michael Atef Ayoub, Irvine, CA (US); Nabil Wasily, Foothill Ranch, CA (US)

(73) Assignee: Thirdwayv, Inc., Irvine, CA (US)

(21) Appl. No.: 19/106,155

(22) PCT Filed: Sep. 27, 2023
(86) PCT No.: PCT/US2023/033901

§ 371 Date: Feb. 24, 2025

Related U.S. Application Data
(60) Provisional application No. 63/411,582, filed on Sep. 29, 2022.

(51) Int. Cl. G06Q 20/06; G06Q 20/20; G06Q 20/34; G06Q 20/36; G06Q 20/38

(52) U.S. Cl. CPC G06Q 20/0658; G06Q 20/20; G06Q 20/341; G06Q 20/352; G06Q 20/3672; G06Q 20/3678; G06Q 20/3825; G06Q 20/3829; G06Q 20/389

(57) ABSTRACT

A cryptocurrency payment system facilitates electronic transactions at point of sale terminals using cryptocurrency. A payment card may include a secure element to sign a cryptocurrency transaction at a point of sale device. A server may interact with the point of sale terminal and a blockchain to initiate a smart contract or other mechanism for transferring control of cryptocurrency from a buyer cryptocurrency wallet to a seller cryptocurrency wallet. Upon successful transfer, the server may provide an indication of transaction approval to the point of sale terminal. In this manner, cryptocurrency may be utilized for transactions at point of sale devices in a manner similar to conventional payment cards.

### CROSS-REFERENCE TO RELATED APPLICATIONS

This application is based upon and claims the benefit and priority to U.S. Provisional Patent Application No. 63/411,582 entitled “NATIVE CRYPTOCURRENCY PAYMENT SYSTEM USING SMART PAYMENT CARDS AND PAYMENT TERMINALS,” filed on Sep. 29, 2022, the entire content of which is incorporated herein by reference.

### FIELD

The present invention is directed to payment systems, and more specifically, the present disclosure is directed to a native cryptocurrency payment system.

### BACKGROUND

Frequently payment systems include use of a credit card or smartphone payment app to conduct transactions at point of sale terminals. However, such systems are not equipped to conduct transactions with cryptowallets. A cryptowallet is used to generate and store the cryptographic key(s) required for performing cryptocurrency transactions. The key(s) is/are used to sign transactions of cryptocurrency on a blockchain. The key(s) is/are usable for other blockchain activities such as executing smart contracts or signing documents. There remains a need to integrate cryptowallet payment capabilities into a payment system for point of sale terminals in order to enable use of cryptocurrency in transactions at point of sale terminals.

### SUMMARY

A cryptocurrency payment system for point of sale payments is provided. The system may include a payment card and a point of sale payment card terminal. The payment card may include a secure element integrated circuit chip physically in or on the payment card, the secure element integrated circuit chip configured to cryptographically sign transactions associated with a payor cryptocurrency wallet account. The point of sale payment card terminal may be connected to a first electronic network and electronically connectable to the secure element integrated circuit chip through at least one wired or wireless connection. The first electronic network further connects to a blockchain associated with the payor cryptocurrency wallet account. The point of sale payment card terminal receives a cryptographically signed transaction from the payment card and publishes the cryptographically signed transaction to the blockchain to transfer funds from the payor cryptocurrency wallet account to a payee cryptocurrency wallet account identified in the cryptographically signed transaction.

The system may have one or more further features. For instance, in various embodiments, the payment card and the point of sale payment card terminal are EVM-compliant. The secure element integrated circuit chip of the payment card may have a memory storing a private key of an asymmetric cryptographic key pair, the private key for signing the cryptographically signed transactions. The secure element integrated circuit chip may have a processor connected to the memory to increment a monotonically increasing transaction counter that increments by one for every cryptographically signed transaction that is signed by the private key. The secure element integrated circuit chip of the payment card may have a memory storing an identification number comprising a 16-digit primary account number (PAN). The secure element integrated circuit chip may connect to the point of sale payment card terminal through a wireless connection, the wireless connection comprising a Near-Field Communication (NFC) connection. The secure element integrated circuit chip may transmit to the point of sale payment card terminal a public-blockchain-compliant cryptocurrency transaction. The payment card terminal may approve the cryptographically signed transaction in response to acceptance of the cryptographically signed transaction by the blockchain.

A method of cryptocurrency payment by a point of sale payment system is disclosed. The method may include electronically connecting a point of sale payment card terminal to a secure element integrated circuit chip of a payment card. The method may include receiving, by the point of sale payment card terminal, a cryptographically signed transaction associated with a payee cryptocurrency wallet account from the secure element integrated circuit chip of the payment card. The method may include transmitting, by the point of sale payment card terminal, the cryptographically signed transaction over a first electronic network connecting to a blockchain associated with the payee cryptocurrency wallet account. The transmitting of the cryptographically signed transaction initiates a cryptocurrency transfer from the payee cryptocurrency wallet account to a payor cryptocurrency wallet account identified in the cryptographically signed transaction.

The blockchain may include a smart contract published on the blockchain, and the method may include further steps. For instance the method may include attributing a cryptocurrency balance to at least one of (1) a public key and/or (2) a cryptocurrency account address of payor. The method may include storing the public key or the cryptocurrency account address on the blockchain. The method may include storing the cryptocurrency balance on the blockchain. The public key or the cryptocurrency account address may correspond to one or more public key of one or more payment card. The smart contract may expose a function to add cryptocurrency funds to the cryptocurrency balance.

The smart contract may expose a payment function that performs different features. For instance, the payment function may receive the cryptographically signed transaction. The payment function may validate a cryptographic signature of the cryptographically signed transaction using a public key corresponding to a private key of an asymmetric key pair used to sign the cryptographically signed transaction. The payment function may verify that a transaction counter value provided with the cryptographically signed transaction is greater than a previous transaction counter value provided with an immediately preceding call of the payment function. The payment function may verify that an available balance attributed to the public key is greater than or equal to an amount of the cryptographically signed transaction. The payment function may transfer the available balance attributed to the public key to the payee cryptocurrency wallet account.

In various embodiments of the method, the method may include prior to the receiving, by the point of sale payment card terminal, the cryptographically signed transaction, further performing digital signing by the secure element integrated circuit chip of the payment card, using a private key of an asymmetric key pair associated with the payee cryptocurrency wallet account. The cryptographically signed transaction includes a transaction amount and a value of a counter that counts transactions.

The blockchain may include a smart contract published on the blockchain. In such instances, the transmitting the cryptographically signed transaction over the first electronic network includes further specific aspects. For instance, the transmitting may include calling a payment function of the smart contract, wherein calling the payment function includes providing the cryptographically signed transaction to the smart contract. The transmitting may include receiving an indication from the smart contract that the payment function was successfully called. The transmitting may include approving a payment transaction in response to the calling the payment function of the smart contract being successfully called.

In other instances, the transmitting may include transmitting the cryptographically signed transaction to a first server. The transmitting may include calling by the first server, a payment function of the smart contract and providing the cryptographically signed transaction to the smart contract. The transmitting may include receiving, by the first server, an indication from the smart contract that the payment function was successfully called. The transmitting may include communicating, by the first server, an indication to the point of sale payment card terminal that the payment function was successfully called. The transmitting may include approving, by the point of sale payment card terminal, a payment transaction in response to the receiving the communication that the payment function was successfully called.

A further method of cryptocurrency payment is provided. The method may be for cryptocurrency payment by a server associated with a point of sale payment system, the method may include receiving, by the server, a cryptographically signed transaction, from a combination of a secure element integrated circuit chip of a payment card and a point of sale payment card terminal connected to the payment card. The method may include verifying, by the server and using a transaction database of the server, an authenticity of a signature of the cryptographically signed transaction and an account balance of a payor cryptocurrency account associated with the payment card is greater than or equal to a transaction amount of the cryptographically signed transaction.

In response to the verification indicating that the signature is authentic, and the account balance is greater than or equal to the transaction amount, the method may include further aspects. For instance, the method may include transmitting, by the server, a payment approval message to the point of sale payment card terminal. The method may include transmitting, by the server, a call to a smart contract associated with a blockchain instructing the smart contract to record on the blockchain data corresponding to the cryptographically signed transaction.

### BRIEF DESCRIPTION OF THE FIGURES

A more complete understanding of the present invention may be derived by referring to the detailed description and claims when considered in connection with the Figures, where like reference numbers refer to similar elements throughout the Figures, and:

FIG. 1 is a diagram of components of a cryptocurrency payment system for point of sale payments, in accordance with various embodiments;

FIG. 2 is an example of various features of a cryptocurrency payment system in a transaction accepting a card payment at a point of sale device, in accordance with various embodiments;

FIG. 3 is an example of various payment mechanisms and their general operation at a point of sale device in a cryptocurrency payment system with a payment server illustrated, in accordance with various embodiments;

FIG. 4 illustrates aspects of a smart contract feature of a cryptocurrency payment system, in accordance with various embodiments;

FIG. 5 illustrates a method of cryptocurrency payment by a point of sale payment system, in accordance with various embodiments; and

FIG. 6 illustrates a further method of cryptocurrency payment by a point of sale payment system, in accordance with various embodiments.

### DETAILED DESCRIPTION

Cryptowallets are used to generate and store cryptographic keys required for performing cryptocurrency transactions. Cryptowallets include at least two common varieties. Software wallets are cryptowallets that are a smartphone or desktop application that stores the cryptographic keys and also manages incoming and outgoing transactions. Hardware wallets are cryptowallets that have an embedded device, such as a secure element (SE), that stores the private keys used for signing outgoing transactions. The hardware wallet communicates with a smartphone, desktop, or web application “watch-only wallet” that only stores the corresponding public keys of the hardware wallet's private keys. A watch-only wallet monitors incoming transactions and prepares unsigned outgoing transactions for the embedded device but cannot sign outgoing transactions. The embedded device verifies the transaction details, retrieves the applicable signing key, signs the transaction, and sends the signed transaction back to the smartphone, desktop, or web application to be broadcast to mining nodes.

Hardware cryptowallets are known to be more secure than software cryptowallets because the software cryptowallets coexist with other applications on a smartphone or desktop and thus the private keys are susceptible to software attacks on the shared platform, while the keys in a hardware cryptowallet never leave the embedded device. Access to hardware cryptowallet operations is often protected by a personal identification number (PIN) or sensed biometric such as a fingerprint or facial recognition.

Private keys of a cryptowallet may be generated via a deterministic hierarchical scheme based on a master secret. The master secret is called the seed value. This seed value is important and must be maintained securely. The private keys must also be maintained securely. Moreover, a user may, in some instances, be required to enter a PIN code associated with the cryptowallet to authorize various transactions. The PIN code should also be maintained securely.

In parallel with these security requirements, wallet users also desire operational convenience. Frequently it is convenient for a cryptowallet to have a physical component similar in form factor and use case to a conventional credit card. However, conventional cryptowallet systems typically lack this integration with payment transaction systems. This can make it difficult to execute a cryptocurrency transaction for conventional trade in goods and services. Thus, there remains a need for integration of cryptocurrency transaction capabilities into a point of sale payment transaction system.

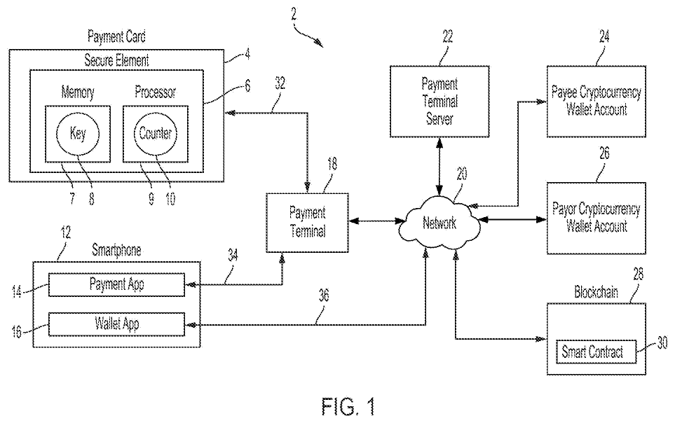

With reference to FIG. 1, a cryptocurrency payment system 2 for point of sale payments is provided. The system may include a payment card 4. The payment card 4 may have a form factor similar to a conventional credit card. The payment card 4 may have a secure element integrated circuit chip 6. The secure element integrated circuit chip 6 may be physically in or on the payment card 4. The secure element integrated circuit chip 6 may be configured to cryptographically sign transactions associated with a payor cryptocurrency wallet account 26. For instance, a secure element integrated circuit chip 6 may be a tamper-resistant platform capable of securely hosting applications and their confidential and cryptograph data. For instance, a secure element integrated circuit chip 6 may have a memory 7 and a processor 9 for storage of seeds, or private keys and for execution of cryptographic operations with seeds or private keys. For instance, one or more of key pairs may be generated within the SE, for enhanced security, such that the key is hardware-backed and cannot be retrieved outside a SE. In various instances, one or more of the private key 8 is retained in a SE. This also facilitates improved security. By retaining the private key 8 within the SE, the private key 8 is secured from retrieval outside the SE but may still be utilized for cryptographic operations. The secure element integrated circuit chip 6 may store at least a portion of a key pair, for instance, the key pair may be an asymmetric cryptography key pair with a private key 8 and a public key. The secure element integrated circuit chip 6 may secure the portion of the key pair comprising the private key 8. The secure element integrated circuit chip 6 may also include a processor 9. The processor 9 may increment a monotonic counter 10. The monotonic counter 10 may be a counter that counts a number of transactions signed by the private key 8 of the key pair. The secure element may store the private key 8, parse a cryptocurrency transaction, and/or conduct other cryptocurrency operations.

The secure element integrated circuit chip 6 may be connectable to a payment terminal 18. For instance, the secure element integrated circuit chip 6 may connect to a payment terminal 18 wirelessly, such as via a near field communication technology, or wiredly such as by physical insertion into the payment terminal 18. Stated differently, the secure element integrated circuit chip 6 may connect to the payment terminal 18 via a card payment communication channel 32. The secure element integrated circuit chip 6 and payment card 4 combination may have a form factor similar to a conventional credit card with a chip. In this manner, the payment card 4 may comprise a secure element integrated circuit chip 6 physically in or on the payment card 4, the secure element integrated circuit chip 6 configured to cryptographically sign transactions associated with payor cryptocurrency account. The payment terminal 18 may be electronically connectable to the secure element integrated circuit chip 6 through at least one card payment communication channel 32 such as a wired or wireless connection.

The payment terminal 18 may be provided. The payment terminal 18 may be a point of sale payment card terminal connected to a first electronic network 20. The payment terminal 18 may accept insertion of a payment card 4, and/or may accept “tap” payments by placing a payment card 4 in physical proximity to the payment terminal 18.

In various embodiments, other mechanisms for transactions other than a payment card 4 may be contemplated. For example, the payment terminal 18 may interact with a smartphone 12. In various embodiments, a smartphone 12 is a computing device connectable to a cellular communication network and having a processor for running applications. The smartphone 12 may also be a special purpose device for payment transactions, rather than a general purpose cellular-connected computer. In various embodiments, the smartphone 12 has a payment application 14. The payment application 14 may include one or more private key, public key, or other mechanism to access a smart contract 30 and or payor cryptocurrency wallet account 26 by which the payment application 14 operates similarly to a payment card 4. The payment application 14 may interact with the payment terminal 18 over a payment application communication channel 34. The payment application communication channel 34 may be a wireless connection, or an optical connection, or another connection as desired. For instance, the payment application 14 may interact with the payment terminal 18 via near-field communication (NFC), different types of wireless RF communication, a readable QR code, or another medium.

In further instances, the smartphone 12 may interact directly with the first electronic network 20 to which the payment terminal 18 would be attached. In this manner, the smartphone 12 may act as both the payment card 4 and as the payment terminal 18. For instance, the smartphone 12 may have a wallet application 16. The wallet application 16 may interact with other resources connected to the first electronic network 20 such as with a smart contract 30. The wallet application 16 may connect to the network via a wallet application communication channel 36. For instance, the wallet application 16 may connect to the first electronic network 20 via a wireless connection, such as a cellular network, a Wi-Fi network, or another RF communication technology. The wallet application 16 may include one or more private key, public key, or other mechanism to access a smart contract 30 and or payor cryptocurrency wallet account 26 by which the wallet application 16 operates similarly to a payment card 4 but without need for payment terminal 18.

Continuing the discussion of FIG. 1, a first electronic network 20 is provided. The first electronic network 20 may be in electronic communication with the payment terminal 18, and in various embodiments, a smartphone 12 having a payment application 14 and/or a wallet application 16. The first electronic network 20 further connects to a blockchain 28. A blockchain 28 comprises a distributed ledger. The distributed ledger may have a list of records (e.g., blocks) that are securely linked together via cryptographic hashes. Each block may contain a cryptographic hash of the previous block, a timestamp, and transaction data. In various embodiments, the transaction data is represented as a Merkle tree, where data nodes are represented by leaves. Since each block contains information about the previous block, the blocks form a chain. As such, a transaction may be recorded on the blockchain 28 and once recorded, be irreversible because the data in any block cannot be altered without altering each subsequent block. In various embodiments, the blockchain 28 is a distributed public ledger implementing a consensus algorithm protocol to add and validate new transaction blocks. This significantly ameliorates the risk of double spending of a cryptocurrency without the need to have a central server or authority.

A cryptocurrency is a medium of exchange through a computer network that is decentralized so that no central authority is required to verify that the parties to a transaction have the claimed currency. Ownership of amounts of cryptocurrency is stored in the decentralized distributed ledger of the blockchain 28 connected to the payment terminal 18 via the first electronic network 20. The cryptocurrency associated with the blockchain 28 may be utilized by the payment card 4 or the smartphone 12 to engage in transactions at the payment terminal 18, exchanging cryptocurrency for goods or services provided by an entity associated with the payment terminal 18.

In various instances, the blockchain 28 includes one or more smart contract 30. A smart contract 30 is a program that is stored on the blockchain 28 and that runs when predetermined conditions are met. For instance, a smart contract 30 may automate an execution of a payment agreement upon an agreed action. For instance, a smart contract 30 may automate payment of cryptocurrency from one cryptowallet to another cryptowallet in response to a predetermined action, such as an interaction of a smartphone 12 with a payment terminal 18. In this manner, payment transactions may be executed by unsecure devices without revealing a user's private keys to an unsecure device. For instance, an unsecure smartphone application may interact with a payment terminal 18 to trigger a smart contract 30 on a blockchain 28 to cause a payor cryptocurrency wallet account 26 (and/or an associated device, such as a server) to sign a cryptocurrency transaction with a private key in the payor cryptocurrency wallet account 26, thereby ameliorating an exposure risk that would result if the private key were on the smartphone 12 or the payment application 14.

The first electronic network 20 may also be connected to cryptocurrency wallet accounts. A cryptocurrency wallet account is a device, physical medium, program or a service that stores public and/or private keys for cryptocurrency transactions. The keys are used to encrypt and/or sign information such as transfers of cryptocurrency from one wallet account to another wallet account. The keys are used to track ownership, receipt, and spending of the cryptocurrency. A public key allows others to make payments to an address derived from the public key and a private key allows spending of the cryptocurrency from that address. The cryptocurrency is decentrally stored and maintained in a publicly available distributed ledger (the blockchain 28), while the keys are associated with the wallets. The first electronic network 20 may both be connected to both a payee cryptocurrency wallet account 24 and a payor cryptocurrency wallet account 26.

As mentioned, the cryptocurrency payment system 2 may include a payment terminal 18. The payment terminal 18 may be a point of sale device having the ability to connect to a payment card 4 and/or a smartphone 12. The payment terminal 18 may have a slot to receive a payment card 4. The payment terminal 18 may have a wireless transceiver to connect to a corresponding device on the payment card 4, such as a ‘tappable’ card that can be placed in proximity to the payment terminal 18. The payment terminal 18 may wirelessly connect to a smartphone 12 having a payment application 14, such as by NFC communication. The payment terminal 18 may connect to a smartphone 12 such as via an optical reader to read a QR code or other code. The payment terminal 18 may have an associated payment terminal server 22. The payment terminal server 22 comprises a computer connected to the payment terminal 18 via the first electronic network 20 that has processing capability to interoperate with the payment terminal 18 to indicate whether attempted transactions are approved or denied, and to interoperate with other resources connected to the first electronic network 20 to effectuate an exchange of currency or cryptocurrency between wallet accounts on a blockchain 28.

Having initially discussed a network architecture of a cryptocurrency payment system 2, now is a convenient time to describe an embodiment of the cryptocurrency payment system 2. For example, a cryptocurrency payment system 2 for point of sale payments includes a payment card 4 comprising a secure element integrated circuit chip 6 physically in or on the payment card 4, the secure element integrated circuit chip 6 configured to cryptographically sign transactions associated with a payor cryptocurrency wallet account 26. The system also includes a payment terminal 18 connected to a first electronic network 20 and electronically connectable to the secure element integrated circuit chip 6 through at least one wired or wireless connection (card payment communication channel 32). The first electronic network 20 further connects to a blockchain 28 associated with the payor cryptocurrency wallet account 26. The payment terminal 18 receives a cryptographically signed transaction from the payment card 4 and publishes the cryptographically signed transaction to the blockchain 28 to transfer funds from the payor cryptocurrency wallet account 26 to a payee cryptocurrency wallet account 24 identified in the cryptographically signed transaction. The payment card 4 and the payment terminal 18 may be EVM-compliant.

The secure element integrated circuit chip 6 has various features. For instance, a memory 7 stores a private key 8 of an asymmetric cryptographic key pair, the private key 8 for signing the cryptographically signed transactions. A processor 9 is connected to the memory 7 to increment a monotonically increasing transaction counter that increments by one for every cryptographically signed transaction that is signed by the private key 8. The secure element integrated circuit chip 6 of the payment card 4 may have a memory 7 storing an identification number comprising a 16-digit primary account number (PAN).

The secure element integrated circuit chip 6 may connect to the payment terminal 18 to allow the card to be tapped rather than inserted into the payment terminal 18. For instance, the secure element integrated circuit chip 6 may connect to the payment terminal 18 through a wireless connection, the wireless connection comprising a Near-Field Communication (NFC) connection. The secure element integrated circuit chip 6 transmits to the payment terminal 18 a public-blockchain-compliant cryptocurrency transaction. The payment terminal 18 approves the cryptographically signed transaction in response to acceptance of the cryptographically signed transaction by the blockchain 28. The payment terminal 18 denies the cryptographically signed transaction in response to rejection of the cryptographically signed transaction by the blockchain 28. The payment terminal server 22 may monitor this acceptance or denial which then sends an electronic indication of approval or denial to the payment terminal 18 via the first electronic network 20 and the payment terminal 18 then may display a visual, audible, or other indicator of approval and/or denial.

In another example embodiment, cryptocurrency payment system 2 for point of sale payments includes a smartphone-based payment application 14 having a private key to cryptographically sign transactions associated with a payor cryptocurrency wallet account 26. A payment terminal 18 is connected to a first electronic network 20 and electronically connectable to the smartphone-based payment application 14 through at least one wired or wireless connection. The first electronic network 20 further connects to a blockchain 28 associated with the payor cryptocurrency wallet account 26. The payment terminal 18 receives a cryptographically signed transaction from the smartphone-based payment application 14 and publishes the cryptographically signed transaction to the blockchain 28 to transfer funds from the payor cryptocurrency wallet account 26 to a payee cryptocurrency wallet account 24 identified in the cryptographically signed transaction.

The smartphone-based payment application 14 may be configured to do different things. For instance, the smartphone-based payment application 14 may generate an asymmetric cryptographic key pair. The private key of the key pair is used for cryptographically signing the cryptographically signed transaction. The smartphone-based payment application 14 may store a card identification number. The smartphone-based payment application 14 may have a cryptocurrency balance attributed to a public key of the smartphone-based payment application 14 on a smart contract 30. In some scenarios the smartphone-based payment application 14 identifies the payee cryptocurrency wallet account 24 by scanning a QR code associated with an address of the payee cryptocurrency wallet account 24.

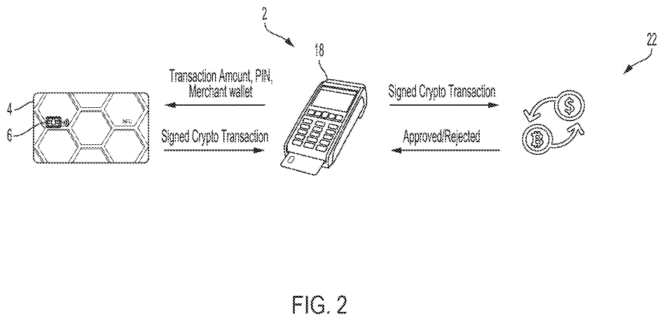

Having discussed various network architectures of a cryptocurrency payment system 2, attention is now directed to FIG. 2, for a discussion of various use scenarios of the cryptocurrency payment system 2. In FIG. 2, a scenario is illustrated where an EVM point-of sale terminal (e.g., payment terminal 18) accepts native cryptocurrency transactions at a point of sale without requiring prior conversion into fiat currency. A payment terminal 18 sends a transaction amount, the merchant wallet address (payee cryptocurrency wallet account 24 address) and a PIN number entered by a user on a keypad to a payment card 4. A secure element of the payment card 4 then signs a cryptocurrency transaction and provides the signed transaction to the payment terminal 18. The payment terminal 18 transmits this signed transaction to a payment terminal server 22 which interoperates with a blockchain 28 to determine whether to approve or deny the transaction. The payment terminal server 22 returns a message corresponding to approval or denial back to the payment terminal 18 for display to a user.

Notably, the payment card 4 may have features such as compliance with ISO-7816 standards for contact payments and ISO-14443 for contactless payments. The card may receive payment card 4 sends a signed cryptocurrency transaction to the payment terminal 18. In the context of smart cards, an application protocol data unit (APDU) is the communication unit between a smart card reader and a smart card. The payment card 4 is configured to receive and properly decode APDUs from the payment terminal 18. As mentioned, the secure element integrated circuit chip 6 of the payment card 4 may be protected by a personal identification number (PIN) code that must be correctly entered into the payment terminal 18 prior to the secure element integrated circuit chip 6 signing the transaction. Advantageously, a user of the payment card 4 is able to set card policies such as when to require a PIN, maximum transaction amount, etc., such as via a smart contract.

The payment terminal server 22 communicates with the payment terminal 18 and the blockchain 28 so that a standard EVM point of sale payment terminal device may be the payment terminal 18. The payment terminal server 22 receives the signed transaction from the payment terminal 18 and publishes the transaction to a smart contract 30 (FIG. 1) of a blockchain 28 (FIG. 1). The payment terminal server 22 sends a transaction authorization to the payment terminal 18, as mentioned, and also settles merchant transactions to fiat currency such as U.S. Dollars at a predetermined time or schedule.

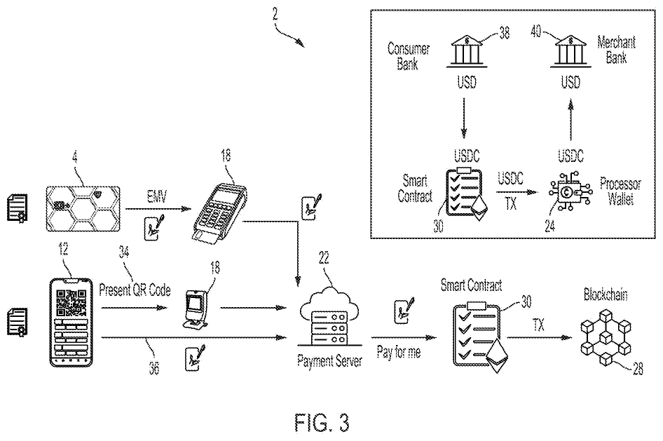

FIG. 3 provides another view of various flows of various data through the cryptocurrency payment system 2. Thus, it may be useful to refer to FIG. 3 and FIG. 1 together in the following discussion. A payment card 4 provides a signed transaction to a payment terminal 18. The payment terminal 18 provides the signed transaction to a payment terminal server 22. In another instance, a smartphone 12 presents a QR code associated with a payor cryptocurrency wallet account 26 to a payment terminal 18. The payment terminal 18 provides corresponding data to the payment terminal server 22. In further instances, a smartphone 12 communicates directly to the payment terminal server 22 via a wallet application 16 and a wallet application communication channel 36 to provide a signed transaction to the payment terminal server 22. The payment terminal server 22 in each instance accesses a smart contract 30 on a blockchain 28 to initiate a funds transfer from a payor cryptocurrency wallet account 26 to a payee cryptocurrency wallet account 24.

This instantiates a flow of funds from a consumer bank 38, to a smart contract 30 to fund the smart contract 30, then to a cryptocurrency wallet (e.g., payee cryptocurrency wallet account 24) which can then be settled as fiat currency at a merchant bank 40, thereby causing the goods or services to be paid for.

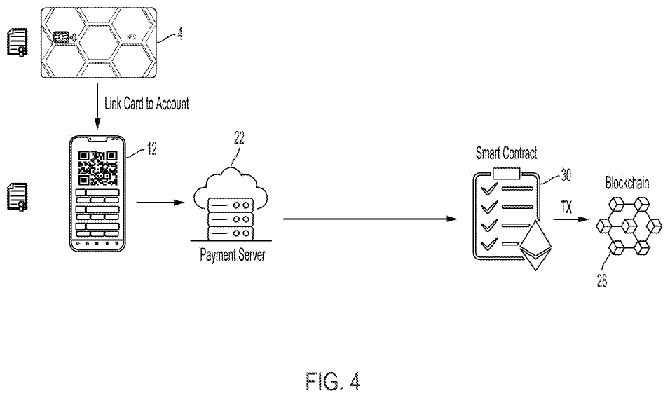

The smart contract 30 may have various useful features. For instance, with reference to FIG. 4 (and ongoing reference to FIG. 1) an illustration of ways to set up a smart contract 30 are shown. A payment card 4 may be linked via an application on a smartphone 12 to an account on a cloud service. The account may provide linkage between a bank account or cryptowallet and a smart contract being funded from the bank account or cryptowallet and may also provide linkage to the payment card 4. The application provides this information to a payment terminal server 22 which is in communication with the smart contract 30. The payment terminal server 22 may establish merchant fees, merchant rewards, merchant credit, and create a new payor cryptocurrency wallet account 26 that is linked with the card and linked with possible merchant credit and guided by spending rules and limits. This smart contract 30 is recorded to a blockchain 28 and accessed during payment transactions by the payment terminal 18 via the payment terminal server 22.

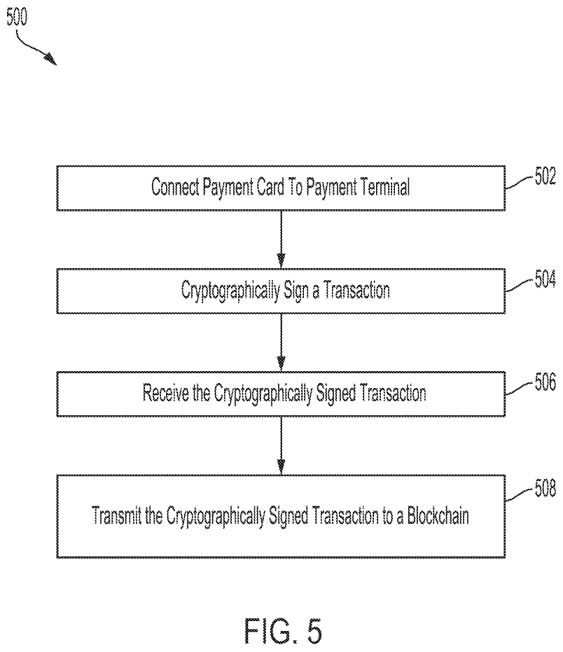

Having introduced the cryptocurrency payment system 2 and aspects of the system, now is a convenient time to discuss methods of operating a cryptocurrency payment system 2. Turning now to FIG. 5, a method 500 of cryptocurrency payment by a point of sale payment system is disclosed. The method may include electronically connecting a point of sale payment card terminal to a secure element integrated circuit chip of a payment card (block 502).

The method may include receiving, by the point of sale payment card terminal, the cryptographically signed transaction associated with a payor cryptocurrency wallet account from the secure element integrated circuit chip of the payment card (block 506). The method may include transmitting, by the point of sale payment card terminal, the cryptographically signed transaction over a first electronic network connecting to a blockchain associated with the payor cryptocurrency wallet account (block 508). The transmitting of the cryptographically signed transaction initiates a cryptocurrency transfer from the payor cryptocurrency wallet account to a payee cryptocurrency wallet account identified in the cryptographically signed transaction.

In various embodiments of the method, the method may include prior to the receiving, by the point of sale payment card terminal, the cryptographically signed transaction, further performing digital signing (block 504) by the secure element integrated circuit chip of the payment card, using a private key of an asymmetric key pair associated with the payor cryptocurrency wallet account. The cryptographically signed transaction include a transaction amount and a value of a counter that counts transactions.

The blockchain may include a smart contract published on the blockchain, and the method may include further steps. For instance the method may include attributing a cryptocurrency balance to at least one of (1) a public key and/or (2) a cryptocurrency account address of payor. The method may include storing the public key or the cryptocurrency account address on the blockchain. The method may include storing the cryptocurrency balance on the blockchain. The public key or the cryptocurrency account address may correspond to one or more public key of one or more payment card. The smart contract may expose a function to add cryptocurrency funds to the cryptocurrency balance.

The smart contract may expose a payment function that performs different features. For instance, the payment function may receive the cryptographically signed transaction. The payment function may validate a cryptographic signature of the cryptographically signed transaction using a public key corresponding to a private key of an asymmetric key pair used to sign the cryptographically signed transaction. The payment function may verify that a transaction counter value provided with the cryptographically signed transaction is greater than a previous transaction counter value provided with an immediately preceding call of the payment function. The payment function may verify that an available balance attributed to the public key is greater than or equal to an amount of the cryptographically signed transaction. The payment function may transfer the available balance attributed to the public key to the payee cryptocurrency wallet account.

As mentioned, the blockchain may include a smart contract published on the blockchain. In such instances, the transmitting the cryptographically signed transaction over the first electronic network includes further specific aspects. For instance, the transmitting may include calling a payment function of the smart contract, wherein calling the payment function includes providing the cryptographically signed transaction to the smart contract. The transmitting may include receiving an indication from the smart contract that the payment function was successfully called. The transmitting may include approving a payment transaction in response to the calling the payment function of the smart contract being successfully called.

In other instances, the transmitting may include transmitting the cryptographically signed transaction to a first server. The transmitting may include calling by the first server, a payment function of the smart contract and providing the cryptographically signed transaction to the smart contract. The transmitting may include receiving, by the first server, an indication from the smart contract that the payment function was successfully called. The transmitting may include communicating, by the first server, an indication to the point of sale payment card terminal that the payment function was successfully called. The transmitting may include approving, by the point of sale payment card terminal, a payment transaction in response to the receiving the communication that the payment function was successfully called.

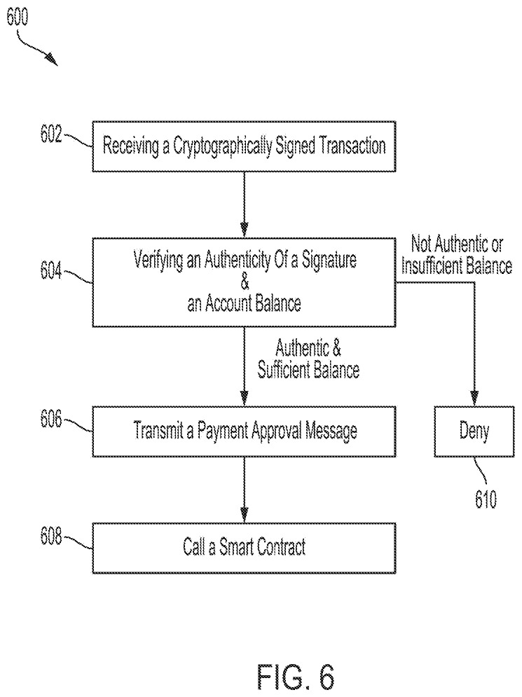

Turning now to FIG. 6, a further method 600 of cryptocurrency payment is provided. The method may be for cryptocurrency payment by a server associated with a point of sale payment system, the method may include receiving, by the server, a cryptographically signed transaction, from a combination of a secure element integrated circuit chip of a payment card and a point of sale payment card terminal connected to the payment card (block 602). The method may include verifying, by the server and using a transaction database of the server, an authenticity of a signature of the cryptographically signed transaction and an account balance of a payor cryptocurrency account associated with the payment card is greater than or equal to a transaction amount of the cryptographically signed transaction (block 604). If the signature is not authentic or the account balance is less than the transaction amount, the method ends with transmitting, by the server, a payment denial message to the point of sale payment card terminal (block 610).

In response to the verification indicating that the signature is authentic, and the account balance is greater than or equal to the transaction amount (block 604), the method may include further aspects. For instance, the method may include transmitting, by the server, a payment approval message to the point of sale payment card terminal (block 606). The method may include transmitting, by the server, a call to a smart contract associated with a blockchain instructing the smart contract to record on the blockchain data corresponding to the cryptographically signed transaction (block 608).

The present disclosure has been described with reference to various embodiments. However, one of ordinary skill in the art appreciates that various modifications and changes can be made without departing from the scope of the present disclosure. For example, features of different embodiments may be combined. Accordingly, the specification is to be regarded in an illustrative rather than a restrictive sense, and all such modifications are intended to be included within the scope of the present disclosure.

The description is of various exemplary embodiments only, and is not intended to limit the scope, applicability, or configuration of the present disclosure in any way. Rather, the description is intended to provide a convenient illustration for implementing various embodiments including the best mode. As has become apparent, various changes may be made in the function and arrangement of the elements described in these embodiments without departing from the scope of the appended claims.

For the sake of brevity, conventional techniques for manufacturing and construction may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical method of construction. As used herein, mechanical communication means any joint, connection, bond, or arrangement whereby an article is held, retained, or fixed in relatively static spatial relationship to another article. As used herein, electronic communication means any wired, wireless, analog, digital, or other mechanism whereby information is communicated between machines, circuits, or devices.

Benefits, other advantages, and solutions to problems have been described herein with regard to various embodiments. However, the benefits, advantages, solutions to problems, and any elements that may cause any benefit, advantage, or solution to occur or become more pronounced are not to be construed as critical, required, or essential features or elements of the invention. Moreover, where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the singular forms “a,” “an,” and “the” include plural referents unless the context clearly dictates otherwise. As used herein, the terms “for example,” “for instance,” “such as,” or “including” are meant to introduce examples that further clarify more general subject matter. Unless otherwise specified, these examples are embodiments of the present disclosure, and are not meant to be limiting in any fashion.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A cryptocurrency payment system for point of sale payments comprising:
a payment card comprising a secure element integrated circuit chip physically in or on the payment card, the secure element integrated circuit chip configured to cryptographically sign transactions associated with a payor cryptocurrency wallet account; and
a point of sale payment card terminal connected to a first electronic network and electronically connectable to the secure element integrated circuit chip through at least one wired or wireless connection,
wherein the first electronic network further connects to a blockchain associated with the payor cryptocurrency wallet account, and
wherein the point of sale payment card terminal receives a cryptographically signed transaction from the payment card and publishes the cryptographically signed transaction to the blockchain to transfer funds from the payor cryptocurrency wallet account to a payee cryptocurrency wallet account identified in the cryptographically signed transaction.

2. The cryptocurrency payment system of claim 1, wherein the payment card and the point of sale payment card terminal are EVM-compliant.

3. The cryptocurrency payment system of claim 1, wherein the secure element integrated circuit chip of the payment card comprises:
a memory storing a private key of an asymmetric cryptographic key pair, the private key for signing the cryptographically signed transactions; and
a processor connected to the memory to increment a monotonically increasing transaction counter that increments by one for every cryptographically signed transaction that is signed by the private key.

4. The cryptocurrency payment system of claim 1, wherein the secure element integrated circuit chip of the payment card comprises a memory storing an identification number comprising a 16-digit primary account number (PAN).

5. The cryptocurrency payment system of claim 1, wherein the secure element integrated circuit chip connects to the point of sale payment card terminal through a wireless connection, the wireless connection comprising a Near-Field Communication (NFC) connection.

6. The cryptocurrency payment system of claim 1, wherein the secure element integrated circuit chip transmits to the point of sale payment card terminal a public-blockchain-compliant cryptocurrency transaction.

7. The cryptocurrency payment system of claim 2, wherein the payment card terminal approves the cryptographically signed transaction in response to acceptance of the cryptographically signed transaction by the blockchain.

8. A method of cryptocurrency payment by a point of sale payment system, the method comprising:
electronically connecting a point of sale payment card terminal to a secure element integrated circuit chip of a payment card;
receiving, by the point of sale payment card terminal, a cryptographically signed transaction associated with a payor cryptocurrency wallet account from the secure element integrated circuit chip of the payment card; and
transmitting, by the point of sale payment card terminal, the cryptographically signed transaction over a first electronic network connecting to a blockchain associated with the payor cryptocurrency wallet account.

9. The method of cryptocurrency payment according to claim 8, wherein the transmitting of the cryptographically signed transaction initiates a cryptocurrency transfer from the payor cryptocurrency wallet account to a payee cryptocurrency wallet account identified in the cryptographically signed transaction.

10. The method of cryptocurrency payment according to claim 8, wherein the blockchain includes a smart contract published on the blockchain, and the method further comprises:
attributing a cryptocurrency balance to at least one of (1) a public key and (2) a cryptocurrency account address of the payor cryptocurrency wallet account;
storing the public key or the cryptocurrency account address on the blockchain; and
storing the cryptocurrency balance on the blockchain.

11. The method of cryptocurrency payment according to claim 9, wherein the public key or the cryptocurrency account address corresponds to one or more public key of one or more payment card.

12. The method of cryptocurrency payment according to claim 9, wherein the method further comprises:
exposing, by the smart contract, a function to add cryptocurrency funds to the cryptocurrency balance.

13. The method of cryptocurrency payment according to claim 9, wherein the method further comprises:
exposing, by the smart contract, a payment function that performs one or more of the following:
(1) receiving the cryptographically signed transaction;
(2) validating a cryptographic signature of the cryptographically signed transaction using a public key corresponding to a private key of an asymmetric key pair used to sign the cryptographically signed transaction;
(3) verifying that a transaction counter value provided with the cryptographically signed transaction is greater than a previous transaction counter value provided with an immediately preceding call of the payment function;
(4) verifying that an available balance attributed to the public key is greater than or equal to an amount of the cryptographically signed transaction; and
(5) transferring the available balance attributed to the public key to the payee cryptocurrency wallet account.

14. The method of cryptocurrency payment according to claim 8, further comprising, prior to the receiving, by the point of sale payment card terminal, the cryptographically signed transaction, further performing digital signing, by the secure element integrated circuit chip of the payment card, using a private key of an asymmetric key pair associated with the payor cryptocurrency wallet account, wherein the cryptographically signed transaction include a transaction amount and a value of a counter that counts transactions.

15. The method of cryptocurrency payment according to claim 8, wherein the blockchain includes a smart contract published on the blockchain, and the transmitting the cryptographically signed transaction over the first electronic network includes:
(a) calling a payment function of the smart contract, wherein calling the payment function includes providing the cryptographically signed transaction to the smart contract;
(b) receiving an indication from the smart contract that the payment function was successfully called; and
(c) approving a payment transaction in response to the calling the payment function of the smart contract being successfully called.

16. The method of cryptocurrency payment according to claim 8, wherein the blockchain includes a smart contract published on the blockchain, and the transmitting the cryptographically signed transaction over the first electronic network includes:
transmitting the cryptographically signed transaction to a first server;
calling by the first server, a payment function of the smart contract and providing the cryptographically signed transaction to the smart contract;
receiving, by the first server, an indication from the smart contract that the payment function was successfully called;
communicating, by the first server, an indication to the point of sale payment card terminal that the payment function was successfully called; and
approving, by the point of sale payment card terminal, a payment transaction in response to the receiving the communication that the payment function was successfully called.

17. A method of cryptocurrency payment by a server associated with a point of sale payment system, the method comprising:
receiving, by the server, a cryptographically signed transaction, from a combination of a secure element integrated circuit chip of a payment card and a point of sale payment card terminal connected to the payment card;
verifying, by the server and using a transaction database of the server, an authenticity of a signature of the cryptographically signed transaction and an account balance of a payor cryptocurrency account associated with the payment card is greater than or equal to a transaction amount of the cryptographically signed transaction;
in response to the verification indicating that the signature is authentic and the account balance is greater than or equal to the transaction amount:
transmitting, by the server, a payment approval message to the point of sale payment card terminal; and
transmitting, by the server, a call to a smart contract associated with a blockchain instructing the smart contract to record on the blockchain data corresponding to the cryptographically signed transaction.

18. A cryptocurrency payment system for point of sale payments comprising:
a smartphone application having a private key to cryptographically sign transactions associated with a payor cryptocurrency wallet account; and
a point of sale payment card terminal connected to a first electronic network and electronically connectable to the smartphone application through at least one wired or wireless connection,
wherein the first electronic network further connects to a blockchain associated with the payor cryptocurrency wallet account, and
wherein the point of sale payment card terminal receives a cryptographically signed transaction from the smartphone application and publishes the cryptographically signed transaction to the blockchain to transfer funds from the payor cryptocurrency wallet account to a payee cryptocurrency wallet account identified in the cryptographically signed transaction.

19. The cryptocurrency payment system of claim 18, wherein the smartphone application is configured to at least one of:
(1) generate an asymmetric cryptographic key pair, wherein the private key of the key pair is used for cryptographically signing the cryptographically signed transaction;
(2) store a card identification number; and
(3) have a cryptocurrency balance attributed to a public key of the smartphone application on a smart contract.

20. The cryptocurrency payment system of claim 18, wherein the smartphone application identifies the payee cryptocurrency wallet account by scanning a QR code associated with an address of the payee cryptocurrency wallet account.
